(19) United States
(12) Patent Application Publication
(10) Pub. No.: US 2012/0166096 A1
(43) Pub. Date: Jun. 28, 2012

(54) METHOD AND SYSTEM FOR TRACKING ENGINE EXHAUST EMISSIONS FROM A JOB

(75) Inventors: Stanley V. Stephenson, Duncan, OK (US); Lon Robinson, Duncan, OK (US)

(73) Assignee: HALLIBURTON ENERGY SERVICES, INC., Houston, TX (US)

(21) Appl. No.: 12/979,183

(22) Filed: Dec. 27, 2010

(51) Int. Cl. G06F 19/00; G05B 13/02

(52) U.S. Cl. 702/23; 700/275

(57) ABSTRACT

A computerized method and system for determining engine exhaust emissions for a job. Job utilization data is stored for each of a plurality of engines used for the job. An amount of engine exhaust emissions for each engine is determined based on the utilization data. An amount of engine exhaust emissions for the job is determined based on the amount of engine exhaust emissions for each engine. The amount of engine exhaust emissions for the job is stored and may, for example, be used for determining job cost, reporting, or controlling the job in real-time.

### TECHNICAL FIELD

Emission tracking system, and more particularly a method and system for tracking engine exhaust emissions produced by equipment used for a well or other job.

### BACKGROUND

Oil and gas wells produce oil, gas and/or byproducts from underground reservoirs. Oil and gas reservoirs are formations of rock containing oil and/or gas. The type and properties of the rock may vary by reservoir and also within reservoirs.

During and/or after drilling, various types of jobs may be performed at a well site. For example, cementing jobs may be performed during drilling to fix casing in the well. During well operation, oil and gas production may be stimulated by fracture, acid or other production enhancement treatment of the well. In a fracture treatment, for example, fluids are pumped down hole under high pressure to artificially fracture the reservoir rock in order to increase permeability and production. Another example of a well job is a wireline job in which a truck with a wireline is used to place well equipment.

Well jobs typically use a large number of trucks and other equipment in order to achieve high pressures and rates or other job requirements. Such equipment may include, for example, pump trucks, sand trucks, and cranes. Costs for various types of jobs may depend on time involved and on the equipment and materials used. For example, the equipment cost of older equipment may be less than that of more modern equipment.

### SUMMARY

A computerized method and system is provided for determining engine exhaust emissions for a job. Job utilization data is stored for each of a plurality of engines used for the job. An amount of engine exhaust emissions for each engine is determined based on the utilization data. An amount of engine exhaust emissions for the job is determined based on the amount of engine exhaust emissions for each engine. The amount of engine exhaust emissions for the job is stored and may be used, for example, for determining job costs, reporting, display and/or controlling the job in real-time.

Technical advantages of the present disclosure include a method and system for planning, conducting and/or charging for a job that accounts for exhaust emission produced by internal combustion engines used to perform the job. For example, emissions may be modeled during a job planning phase, determined in real-time during the job and/or determined after job completion. The emissions data may be used in the job planning phase to select equipment, equipment utilization or job criteria to meet an emissions target, used in real-time to control operations to control or reduce emissions, and/or after the job to charge based on emissions levels. By factoring in emission costs, the job may be conducted to minimize overall job costs including emission costs.

Another technical advantage of the present disclosure includes providing an improved method and system to determine in real-time or otherwise emissions from equipment used in the field. Emissions may be accurately determined based on fuel usage, horsepower and/or utilization time. Fuel usage, horsepower and utilization time may be, for example, directly sensed with data sensors coupled to engines or equipment used to perform the job or determined from data collected for the job.

The details of these and other aspects and embodiments of the disclosure are set forth in the accompanying drawings and the description below. Other features, objects, and advantages of the various embodiments will be apparent from the description and drawings, as well as from the claims.

### DESCRIPTION OF DRAWINGS

FIG. 1 illustrates an embodiment of a job site including equipment for performing a job;

FIG. 2 illustrates an embodiment of a fracture treatment job for the well of FIG. 1;

FIG. 3 illustrates an embodiment of an emission tracking system for determining engine exhaust emissions from equipment used for the job of FIG. 2;

FIG. 4 illustrates an exemplary method for planning, conducting and charging for a job based on an amount of engine exhaust emissions produced by the job;

FIG. 5 illustrates an exemplary method for determining engine exhaust emissions based on equipment run-time and loading for the job;

FIG. 6 illustrates an exemplary method for determining engine exhaust emissions based on work performed by an engine for the job;

FIG. 7 illustrates an exemplary method for determining engine exhaust emissions based on fuel usage by an engine for the job; and

FIGS. 8A-H illustrate exemplary job plan/emissions reports of engine exhaust emissions for jobs.

### DETAILED DESCRIPTION

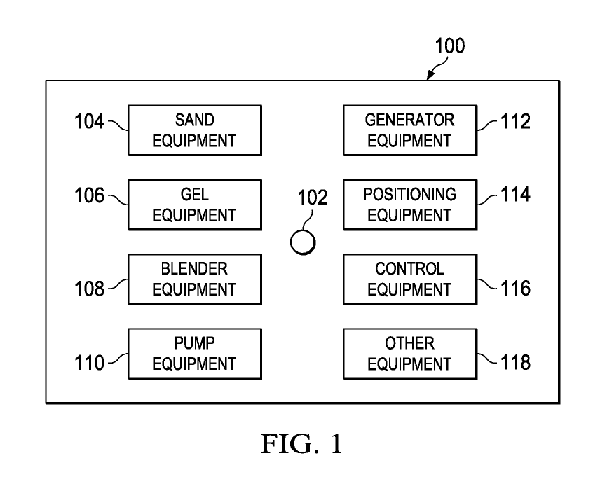

FIG. 1 illustrates a job site 100 in accordance with one aspect of the present disclosure. The job site 100 may comprise a well 102 or other suitable structure at which equipment is used to perform a job. Other types of sites may include, for example, a construction site. The equipment includes one or more internal combustion or other suitable engines that consume fuel to perform work at the site 100.

The well 102 may be a hydrocarbon or other well for producing oil, gas and/or other resources. In this embodiment, the job may comprise, for example, a cementing job, a fracture job or other suitable job where equipment is used to drill, complete, produce, enhance production, and/or work over the well 102. Other jobs may include, for example, operating or construction of a facility.

Referring to FIG. 1, the job site 100, for the illustrated embodiment, includes sand equipment 104, gel equipment 106, blender equipment 108, pump equipment 110, generator equipment 112, positioning equipment 114, control equipment 116 and other equipment 118. The equipment may be, for example, truck or rig-mounted equipment. The sand equipment 104 may include transport trucks for hauling to and storing at the site 100 sand for use in the job. The gel equipment 106 may include transport trucks for hauling to and storing at the site 100 materials used to make a gel for use in the job. The blender equipment 108 may include blenders, or mixers, for blending materials at the site for the job. The pump equipment 110 may include pump trucks for pumping materials down the well 102 for the job. The generator equipment 112 may include generator trucks for generating electric power at the site 100 for the job. The electric power may be used by sensors, control and other equipment. The positioning equipment 114 may include earth movers, cranes, rigs or other equipment to move, locate or position equipment or materials at the site 100 or in the well 102.

The control equipment 116 may include an instrument truck coupled to some, all, or substantially all of the other equipment at the site 100 and/or to remote systems or equipment. The control equipment 116 may be connected by wireline or wirelessly to other equipment to receive data for or during the job. The data may be received in real-time or otherwise. In another embodiment, data from or for equipment may be keyed into the control equipment 116. The control equipment 116 may include a computer system for planning, monitoring, performing or analyzing the job. Such a computer system may be part of a distributed computing system with data sensed, collected, stored, processed and used from, at or by different equipment or locations. The other equipment 118 may comprise equipment also used by or at the job or ancillary to the job. For example, the other equipment 118 may comprise personal or other vehicles used to transport workers to the site 100 but not directly used at the site 100 for the job.

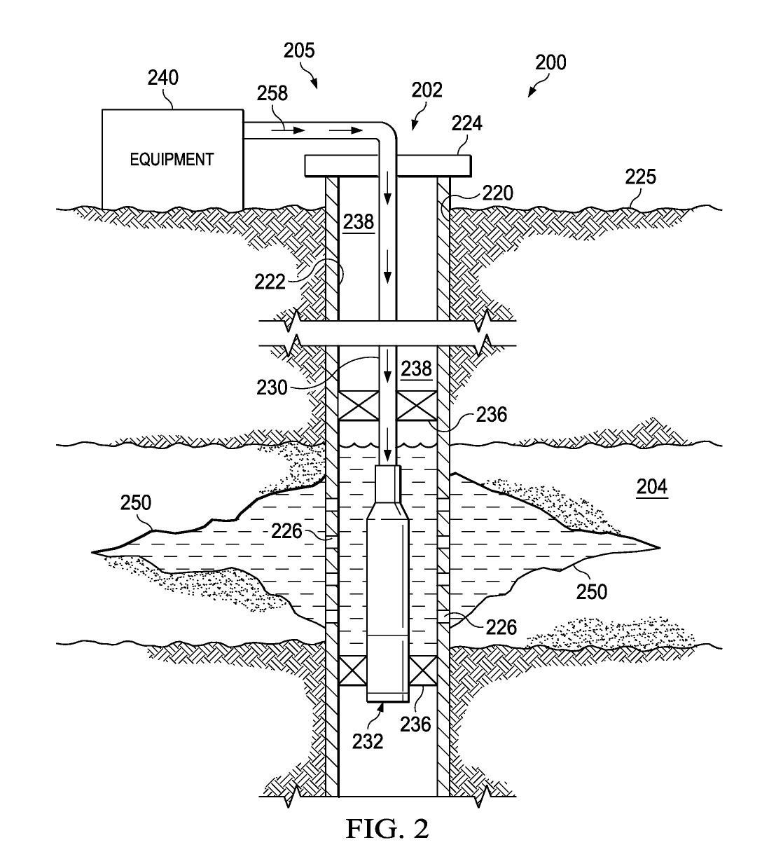

FIG. 2 illustrates one embodiment of a job 200 at a well 202. The well 202 may be an oil and gas well intersecting a reservoir 204. In this embodiment, the reservoir 204 comprises an underground formation of rock containing oil and/or gas. The well 202 may, in other embodiments, intersect other suitable types of reservoirs 204. The job 200 may comprise a fracture treatment job 205 or other suitable operation. For example, the job 200 may be a cementing job or a coiled tubing job on the well 202.

The well 202 may include a well bore 220, a casing 222 and a well head 224. The well bore 220 may be a vertical bore, a horizontal bore, a slanted bore or other deviated bore. The casing 222 may be cemented or otherwise suitably secured in the well bore 202. Perforations 226 may be formed in the casing 222 at the level of the reservoir 204 to allow oil, gas, and by-products to flow into the well 202 and be produced to the surface 225. Perforations 226 may be formed using shape charges, a perforating gun or otherwise.

For the fracture treatment job 205, a work string 230 may be disposed in the well 202. The work string 230 may be coiled tubing, sectioned pipe or other suitable tubing. A fracturing tool 232 may be coupled to an end of the work string 230. The fracturing tool 232 may comprise a SURGIFRAC or COBRA FRAC tool manufactured by HALLIBURTON or other suitable fracturing tool. Packers 236 may seal an annulus 238 of the well 202 above and below the reservoir 204. Packers 236 may be mechanical, fluid inflatable or other suitable packers.

Equipment 240 may be coupled to the work string 230 at the surface 225. For the fracture treatment job 205 and/or other suitable jobs, the equipment 240 may include some or all of the equipment described in connection with FIG. 1. For example, equipment 240 may include pump trucks to pump fracture fluid 258 down the work string 230 to perform the fracture treatment job 205. The fracture fluid 258 may comprise a fluid pad, proppant laden fluid and/or a flush fluid. The pump trucks and other equipment may comprise mobile vehicles, equipment such as skids or other suitable units.

In operation, the fracturing tool 232 is coupled to the work string 230 and positioned in the well 202. The packers 236 are set to isolate the reservoir 204. The pump trucks pump fracture fluid 258 down the work string 230 to the fracturing tool 232. The fracture fluid 258 exits the fracturing tool 232 and creates a fracture 250 in the reservoir 204. In a particular embodiment, a fracture fluid 258 may comprise a fluid pad pumped down the well 202 until breakdown of the formation in the reservoir 204. Proppant laden fluids may then be pumped down-hole followed by a clear fluid flush. The fracture treatment job 205 may be otherwise suitably performed.

During the fracture treatment job 205, the equipment 240 is operated to perform work to accomplish the job 200. During equipment operation, work is performed by engines which consume fuel and produce emissions into the atmosphere. The engines may be operated at idle, at full horsepower, or at other suitable loads. The produced emissions may comprise, for example, carbon dioxide (CO₂), particulate matter (PM), nitrogen oxides (NOₓ), and non-methane hydrocarbon (NMHC) emissions. Utilization data may be estimated, monitored, or otherwise collected from the equipment 240 and/or stored and used in real-time or otherwise to determine the emissions, such as engine exhaust emissions, produced by the job 200. The utilization data may be sensed by sensors coupled to the equipment 240 or engines of the equipment 240 and uploaded to an instrument truck or other suitable data gathering and storage device at the job 200.

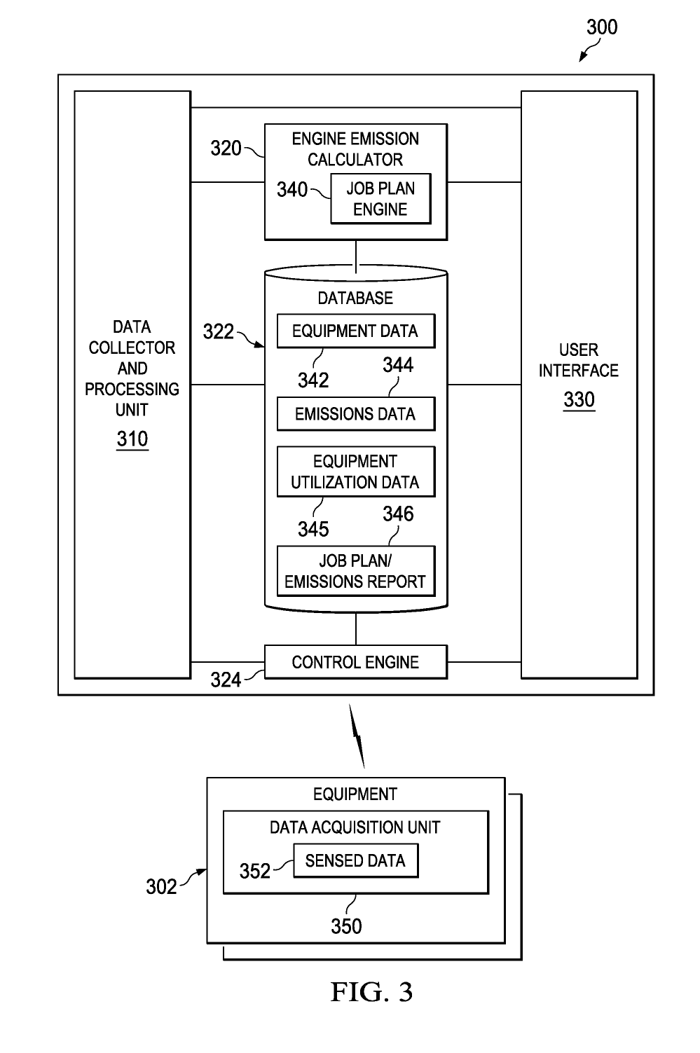

FIG. 3 illustrates one embodiment of an emissions tracking system 300 including or coupled to equipment 302. In this embodiment, the emission tracking system 300 is implemented as a computer program in an integrated computer system such as a personal computer, laptop, or other stand-alone system. In other embodiments, the emission tracking system 300 may be otherwise implemented as a computerized system having a processor for performing actions in accordance with instructions and one or more memory devices for storing instructions and data. Thus, the emission tracking system 300 may be implemented as a distributed computer system with elements of the emission tracking system 300 connected locally and/or remotely by a computer or other communication network.

More specifically processing of the emission tracking system 300 may be controlled by logic which may comprise software and/or hardware instructions. The software may comprise a computer readable program coded and embedded on a computer storage or readable medium for performing the methods, processes and operations of the emission tracking system 300. The computer storage medium can be, or be included in, a computer-readable storage device, a computer-readable storage substrate, a random or serial access memory array or device, or a combination of one or more of them, where some or more may be non-transitory. The computer storage medium can be a source or destination of computer program instructions and can also be, or be included in, one or more separate physical components or media (e.g., multiple CDs, disks, or other storage devices).

The computer program my comprise, for example, software, an application, script, or code can be written in any form of programming language, including compiled or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data such as one or more scripts stored in a markup language document, in a single file dedicated to the program in question, or in multiple coordinated files such as files that store one or more modules, sub programs, or portions of code. A computer program can be deployed to be executed on one computer or on multiple computers that are located at one site or distributed across multiple sites and interconnected by a communication network.

The processor may be any suitable digital or other electronic circuitry for the execution of a computer program and may include, by way of example, both general and special purpose microprocessors. The processor or set of processors execute instructions and manipulate data to perform the operations and may be, for example, a central processing unit (CPU), a blade, an application specific integrated circuit (ASIC), or a field-programmable gate array (FPGA). Generally, a processor will receive instructions and data from a read only memory or a random access memory or both. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device such as a personal digital assistant (PDA) or a portable storage device. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Referring to FIG. 3, the emissions tracking system 300 may include or be connected to equipment 302. The emissions tracking system 300 includes a data collection and processing unit 310, an engine emission calculator 320, a database 322, a control engine 324 and a user interface 330. The data collection and processing unit 310, the engine emission calculator 320, the database 322, the control engine 324, the user interface 330 and/or components thereof may be implemented in a laptop computer and/or be interconnected via software, hardware or over one or more communication links. The communication links may be a wired or wireless links. Thus, the components of the emission tracking system 300 can be interconnected by any form or medium of data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks). The emission tracking system 300 and/or components of the emission tracking system 300 may comprise additional, different, or other suitable components and devices and may be otherwise suitable interconnected.

The data collection and processing unit 310 receives, accesses and/or stores utilization data from equipment 302, which includes the engines of the equipment 320. The utilization data may be received in real-time or uploaded periodically to the data collection and processing unit 310. The utilization data may be received over a communication link or may be manually or otherwise uploaded by an operator via the user interface 330. The utilization data may comprise engine data, horsepower data, fuel data, load data such as time at idle and time at full or other horsepower, run-time data such as period or duration of operation at various states and/or time and date operated, and other suitable data comprising information on the performance or work performed by an engine or item of equipment that generates emissions as a by-product of consuming fuel to perform work. The data collection and processing unit 310 may correlate received signals to a corresponding measured value, filter the data, fill in missing data and/or calculate data derivatives used by one or more of the components of the emission tracking system 300. The data collection and processing unit 310 may comprise data input/output (I/O) and a database or other persistent or non-persistent storage.

The engine emission calculator 320 determines engine exhaust emissions for equipment 302, or the engines of equipment 302, and for a job 200. In one embodiment, the engine emission calculator 320 may access the database 322 to retrieve equipment data 342 for equipment used on the job 200, emissions data 344 for the type of emissions tracked for the job 200 and engine utilization data 345 for the job 200. The engine utilization data may comprise planned, actual or recorded utilization data. The engine emission calculator 320 may calculate the amount of engine exhaust emissions based on the equipment data 342, the emissions data 344 and the utilization data 345. In one embodiment, the engine emission calculator 320 calculates the engine exhaust emissions for each engine and then totals the individual engine exhaust emissions to determine the amount of engine exhaust emissions for the job 200. Other or different data may be used without departing from the scope of the present disclosure.

The engine emission calculator 320 may calculate engine exhaust emissions in real-time during the job 200 or after completion of the job 200. The engine emission calculator 320 may also include a job plan engine 340 to calculate or estimate engine exhaust emissions expected to be produced by the job 200 based on planned equipment 302 and planned use or loading of the equipment 302 to accomplish the job 200. The job plan engine 340 may generate a job plan/emissions report 346 for review by, for example, an operator. The job plan/emissions report 346 may be output on a display of the user interface 330 or, for example, printed. The operator may adjust job plan/emissions report 346 in the job plan engine 340 by changing equipment 302, equipment utilization, or job criteria for the job 200 until a target level of emissions for the job 200 are met. The final job plan/emissions report 346 may be output to the database 322 and stored for use at the job 200.

The job plan engine 340 may also be used in real-time during a job 200 to determine total engine exhaust emissions based on engine exhaust emissions already generated by the job 200 and projected engine exhaust emissions to finish the job 200. Thus, the operator may adjust equipment utilization in real-time during the job 200 to meet emissions targets for the job 200. Also, the control engine 324 may be coupled to or otherwise access the job plan engine 340 to monitor job performance in real-time. The control engine 324 may dynamically adjust operation of the job 200 by automatically controlling operating parameters of the job 200 to meet an emission target. The emission target may, for example, be a total amount of emissions, total amounts of certain types of emissions, or average emissions amount(s) per unit of equipment or unit of time such as per day. The control engine 324 may also automatically control the job 200 or aspects of the job 200 by directing or instructing the operator to make operational changes during the job 200. For example, the job 200 may be controlled by increasing or decreasing utilization of certain on-site equipment 302 in favor of other on-site equipment 302. Thus, the load or run-time of certain equipment 302 may be increased while the load or run-time on other equipment 302 is reduced. The job plan engine 340 and the control engine 324 may be accessed via the user interface 330.

The database 322 stores the equipment data 342, the emissions data 344, the equipment utilization data 344, and the job plan/emissions report 346. The equipment data 342 may, for example, comprise a list of equipment 302 owned or used for performing jobs 200 by unit-type, rated horsepower per engine of the equipment, engine model, Environmental Protection Agency (EPA) tier rating, and fuel usage. Fuel usage may, for example, be an average fuel usage, fuel usage at idle, fuel usage at full horsepower and/or fuel usage at or as a function of load. The emissions data 344 may, for example, comprise emissions of tracked pollutants based on fuel, horsepower and/or fuel usage. For example, the emission data may comprise pounds of CO₂ emissions from a gallon of diesel fuel and gram of PM, gram of NO_{X} and gram of NMHC emissions per horsepower-hour. The emission data 344 may also include data derived from other emissions data such as, for example, emissions for unit time based on equipment load.

The engine utilization data 345 may comprise, for example, a number of units used of each type of equipment for the job 200, run-time at different load states, average horsepower for equipment, load states, fuel usage, pressure and rate from the pump units, and other data from the job 200, equipment used on the job 200 and engines used in the equipment 302 for the job 200. Other, different, or a subset of the illustrated and described data may be stored in database 322 and used in determining engine exhaust emissions for the job 200 without departing from the scope of the present invention.

The job plan/emissions report 346 may initially comprise a job plan that is subsequently updated in real-time during the job 200 and, upon completion of the job 200, comprises an emissions report based on actual job performance. The job plan/emissions report 346 may include all or a part of the equipment data 342, emissions data 344 and equipment utilization data 345. For example, the job plan/emissions report 346 may comprise the number of unit and/or load states of equipment 302, the duration of the load states for equipment 302 and exhaust emissions produced by each item equipment 302, or the engine of the equipment 302. The job plan/emissions report 346 may also include total emissions per job 200, and accumulated emissions for per job type, time period, field or site, client or company. Also included may be formulas, equations, calculations, estimates, and results used to determine the engine exhaust emissions. In one embodiment, for example, cumulative utilization data may be captured daily for each piece of equipment 302 owned or operated by of for a company. When total engine exhaust emissions are needed between any two dates, the cumulative utilization data on the first date may be subtracted from the cumulative utilization data on the second date and the difference between the values used to calculate total emissions between the two dates. Thus, total emissions may be stored for a first period of time and total emissions for a second period of time within the first time period determined. As previously described, engine exhaust emissions may be calculated from fuel usage, horsepower generated, run-time and load, and/or directly sensed.

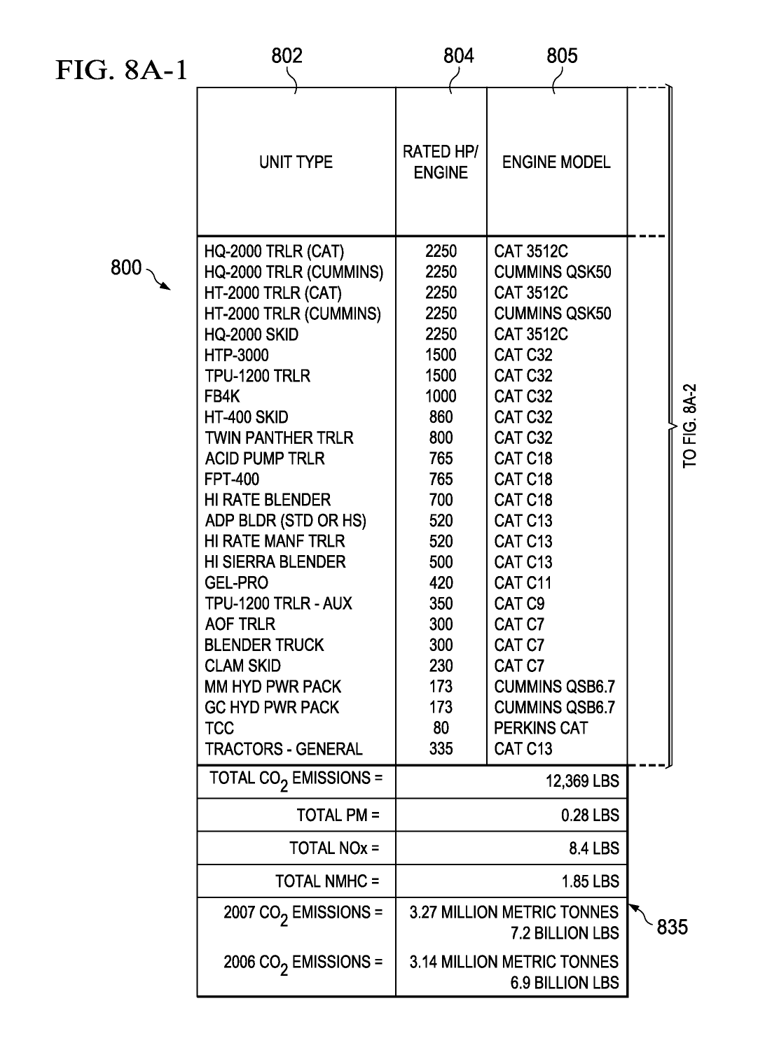

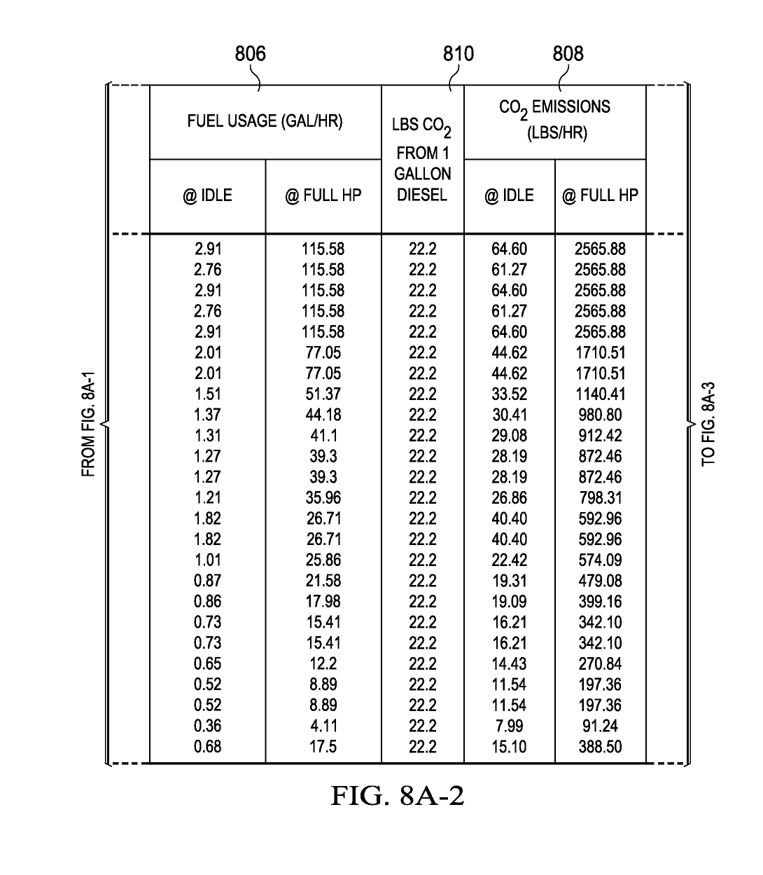

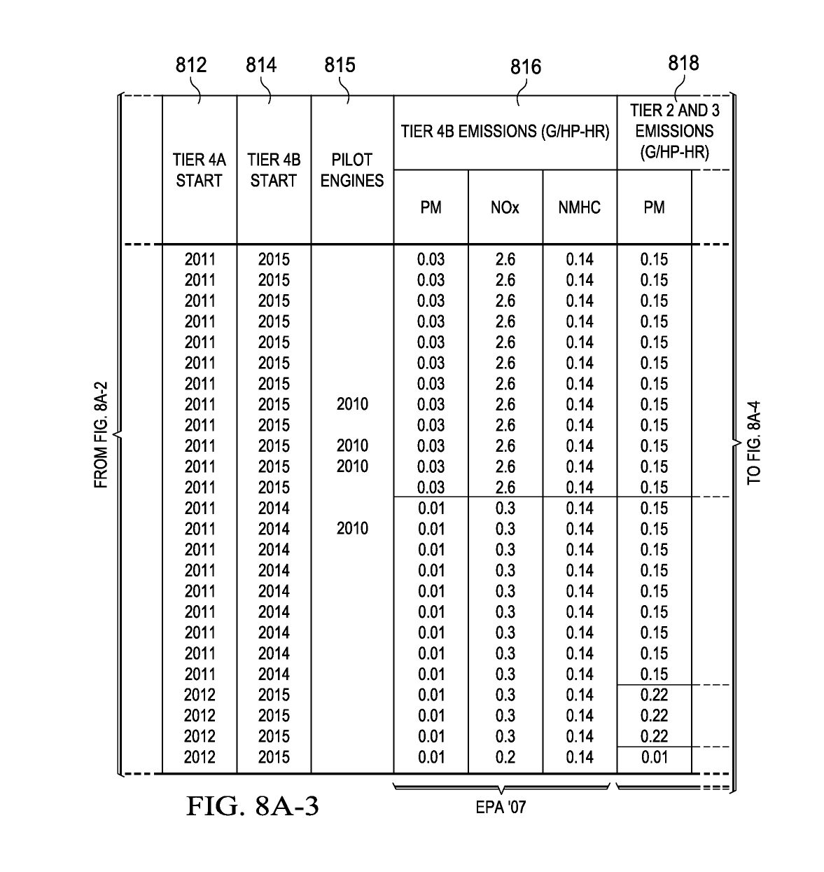

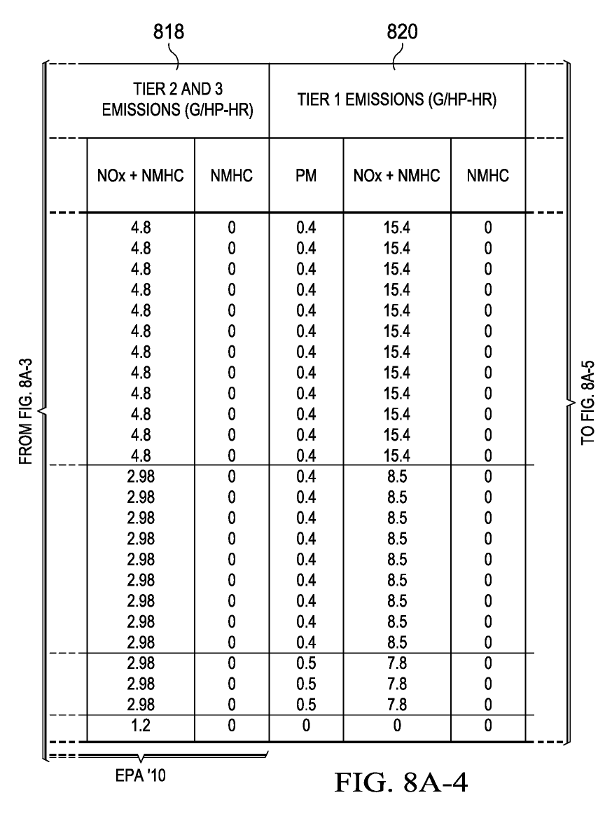

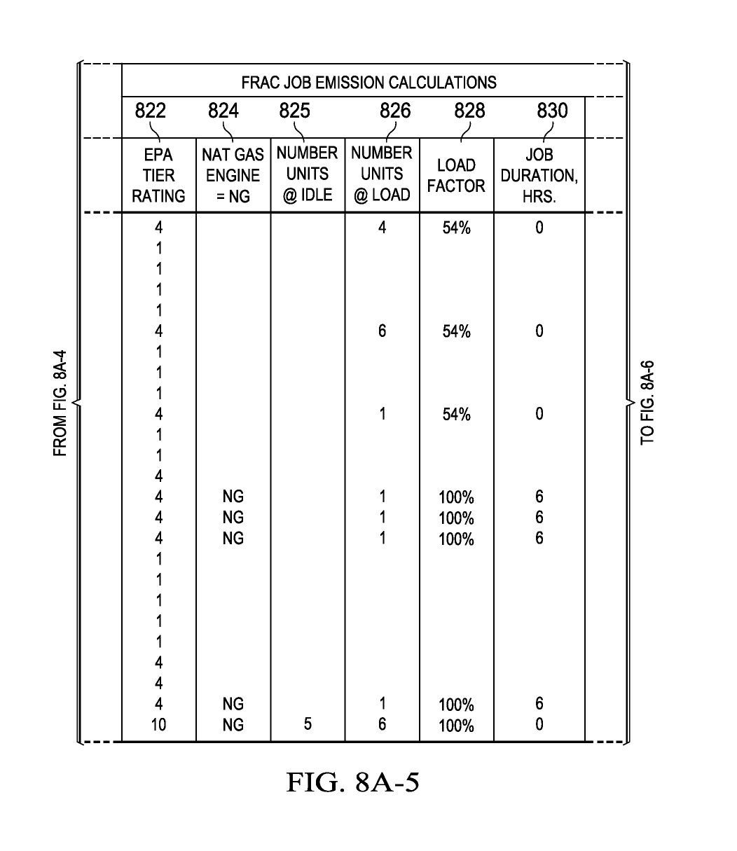

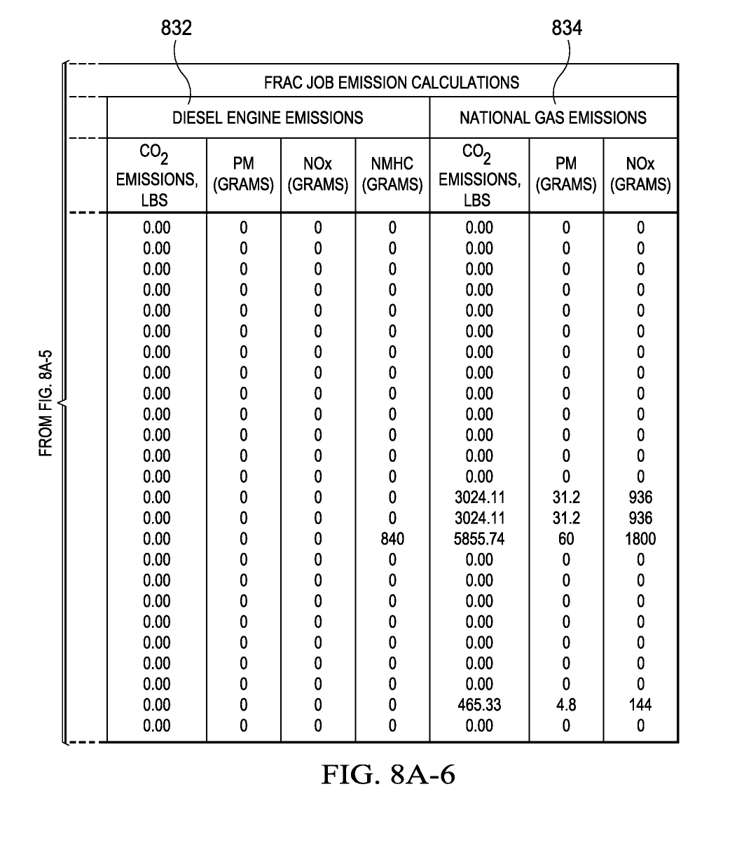

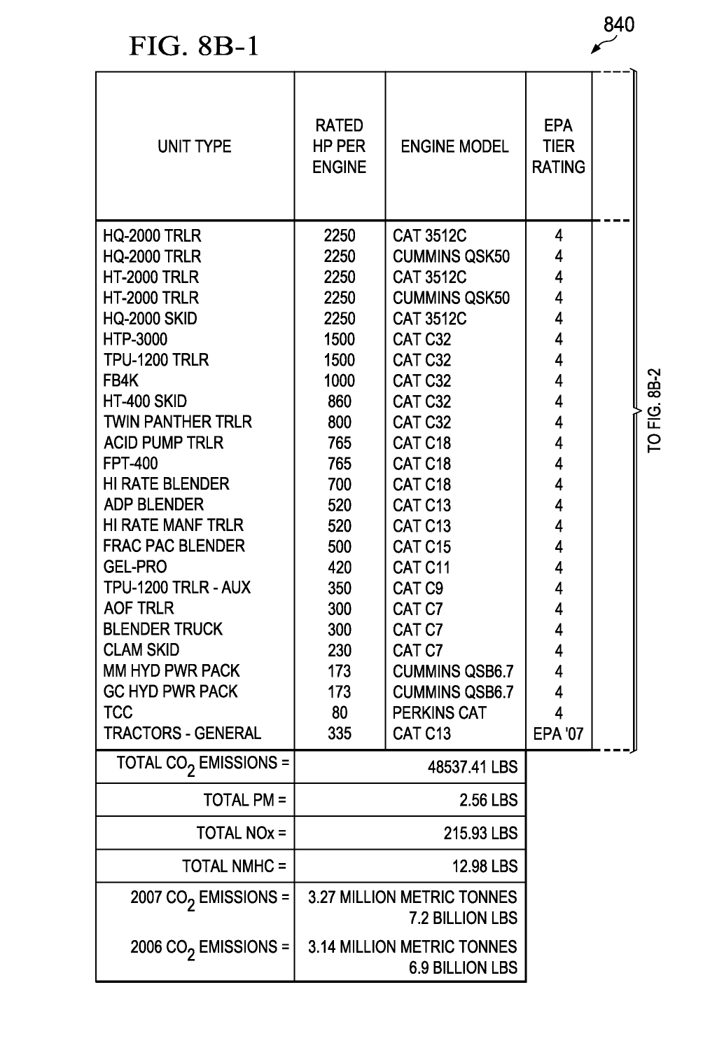

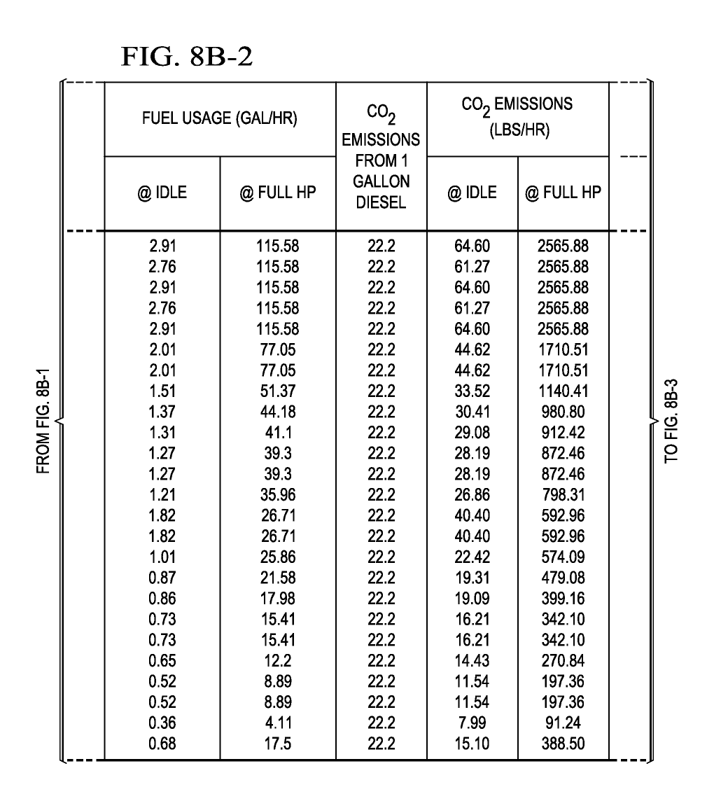

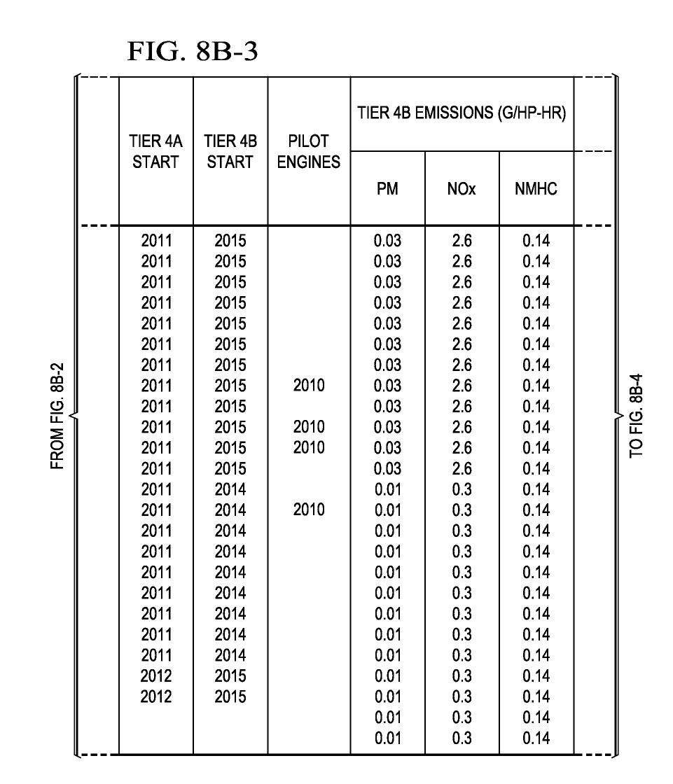

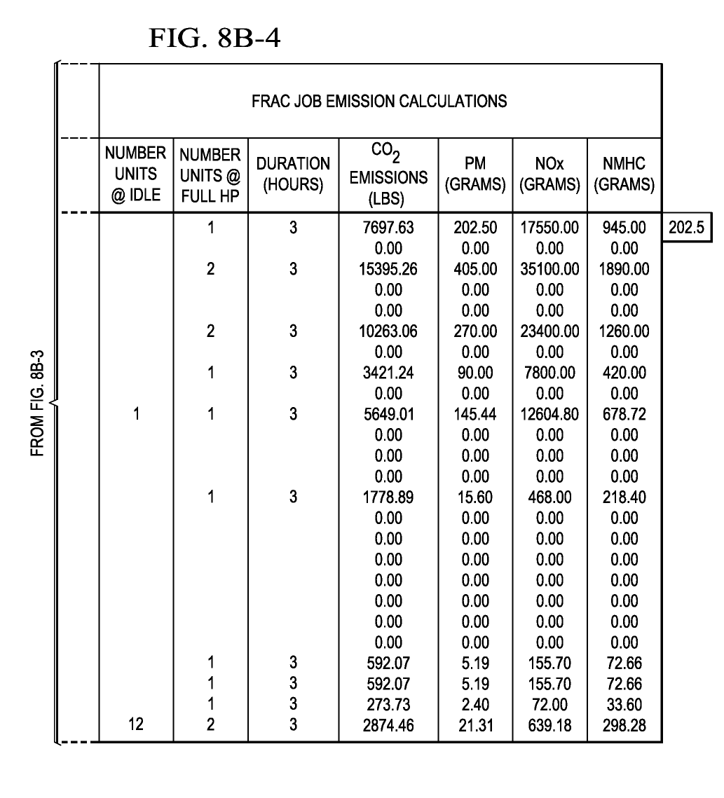

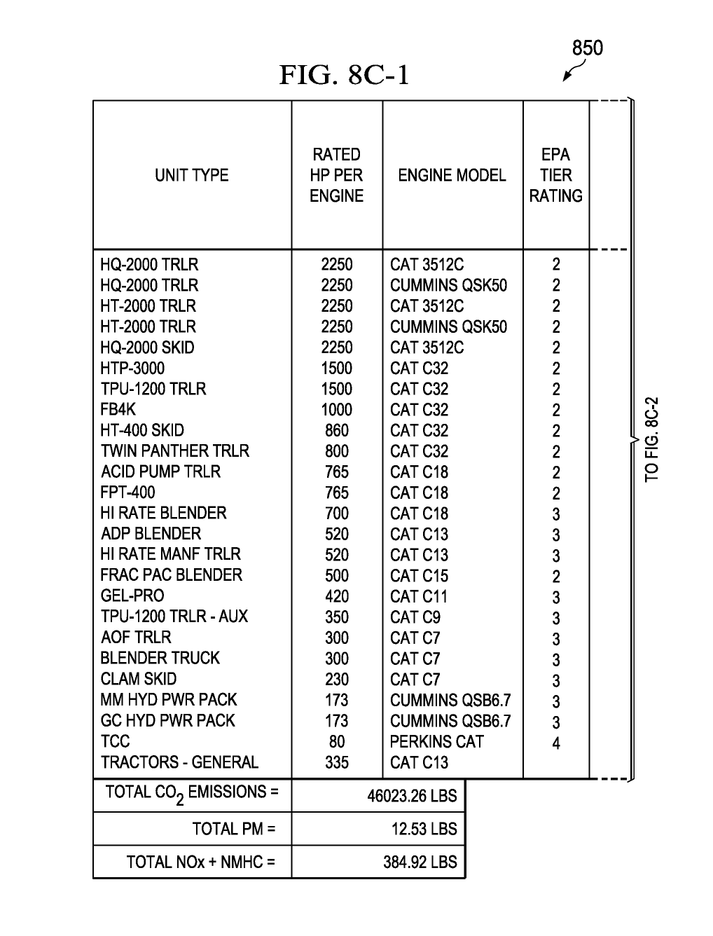

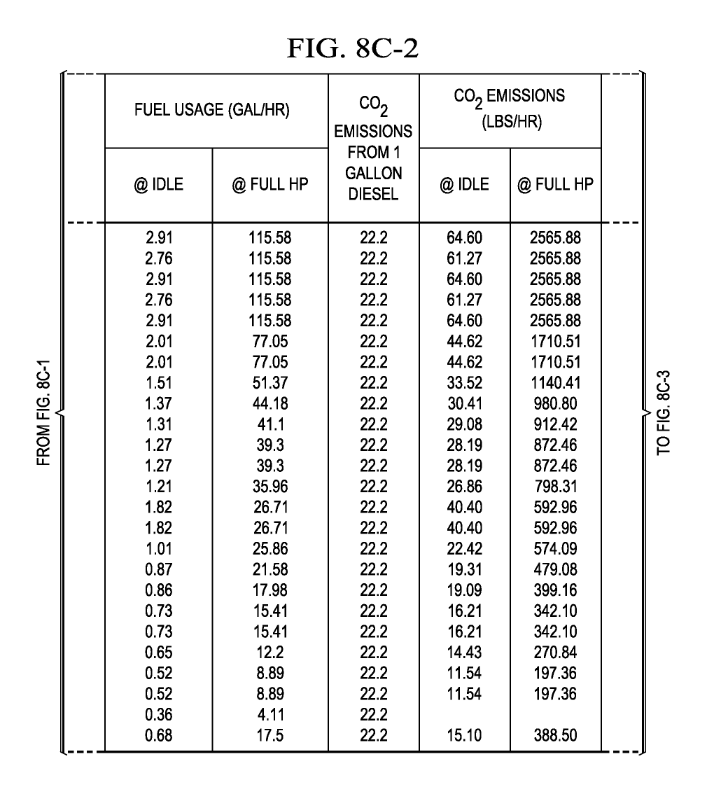

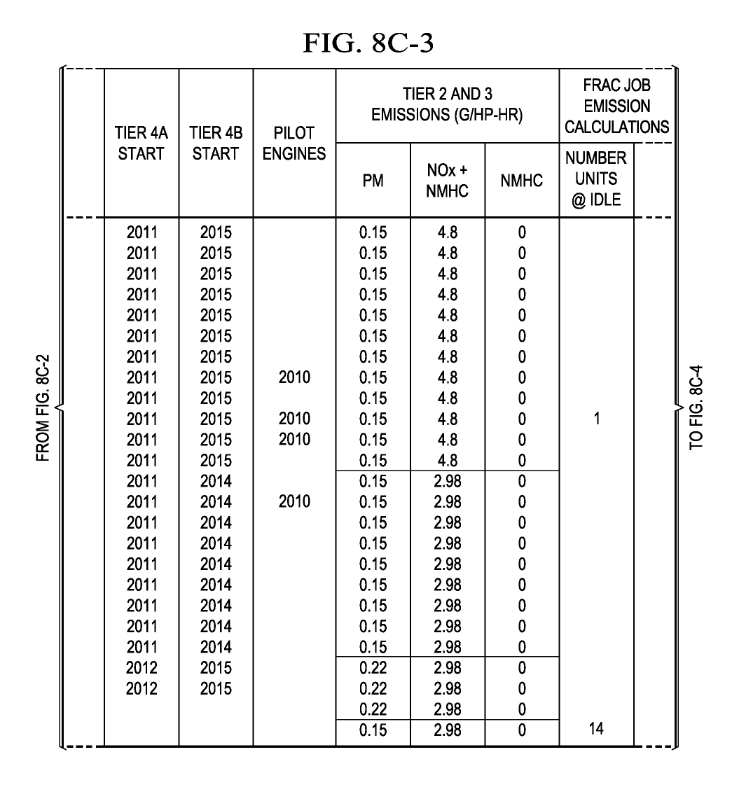

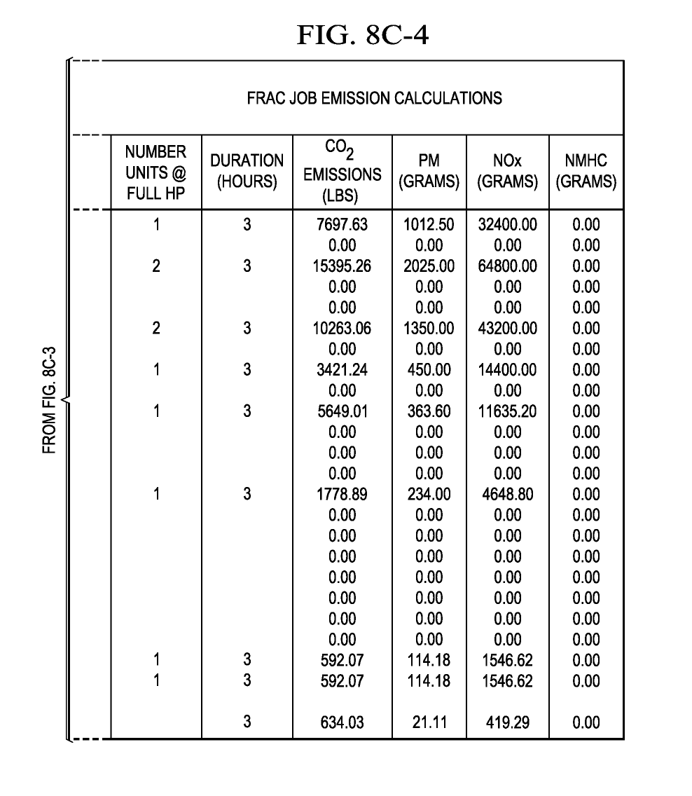

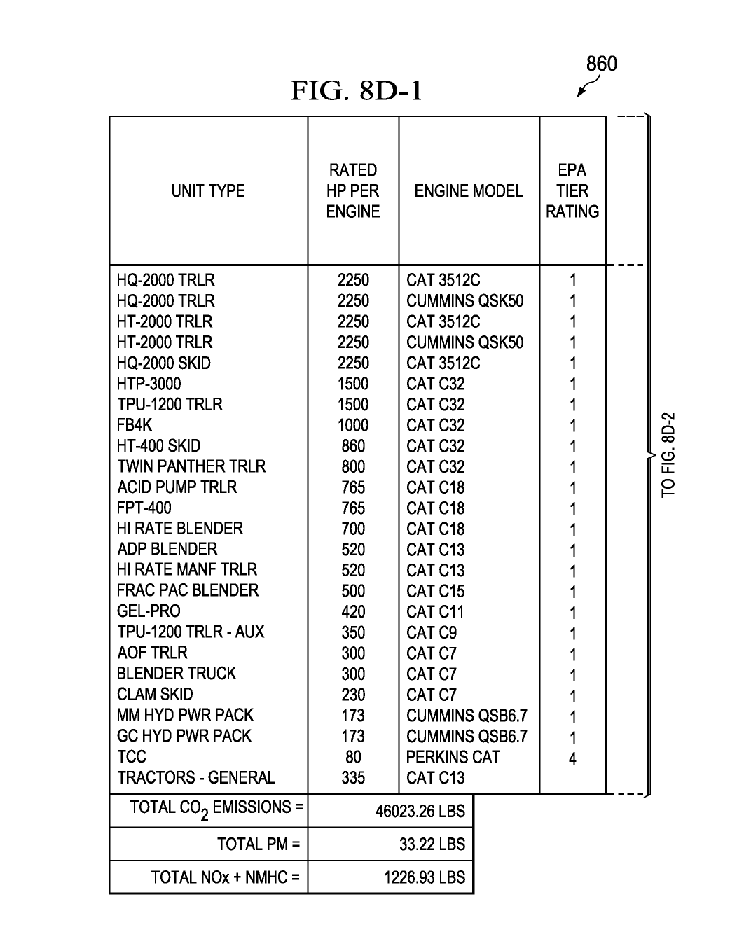

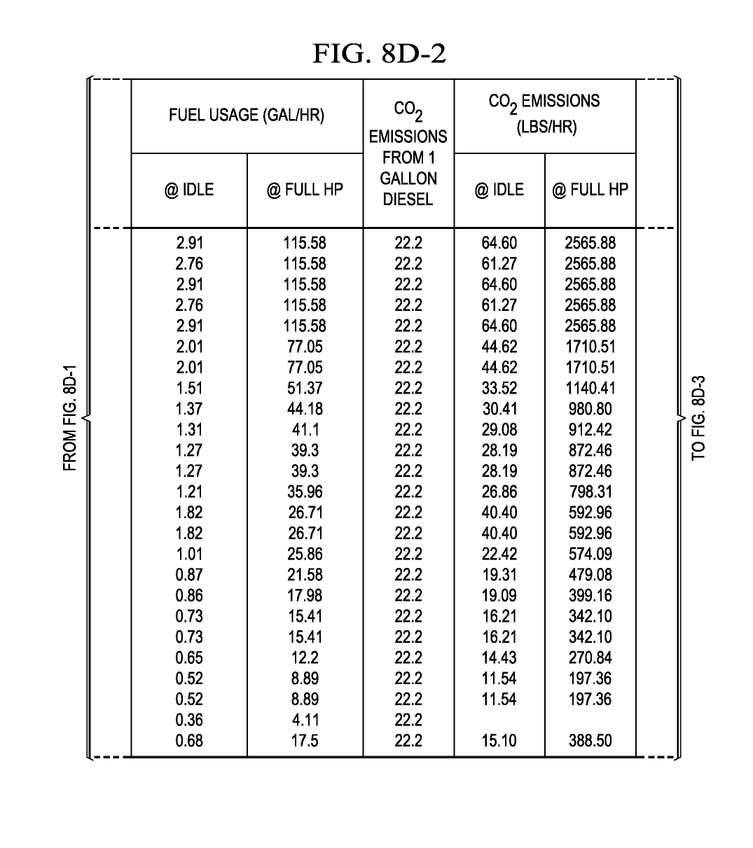

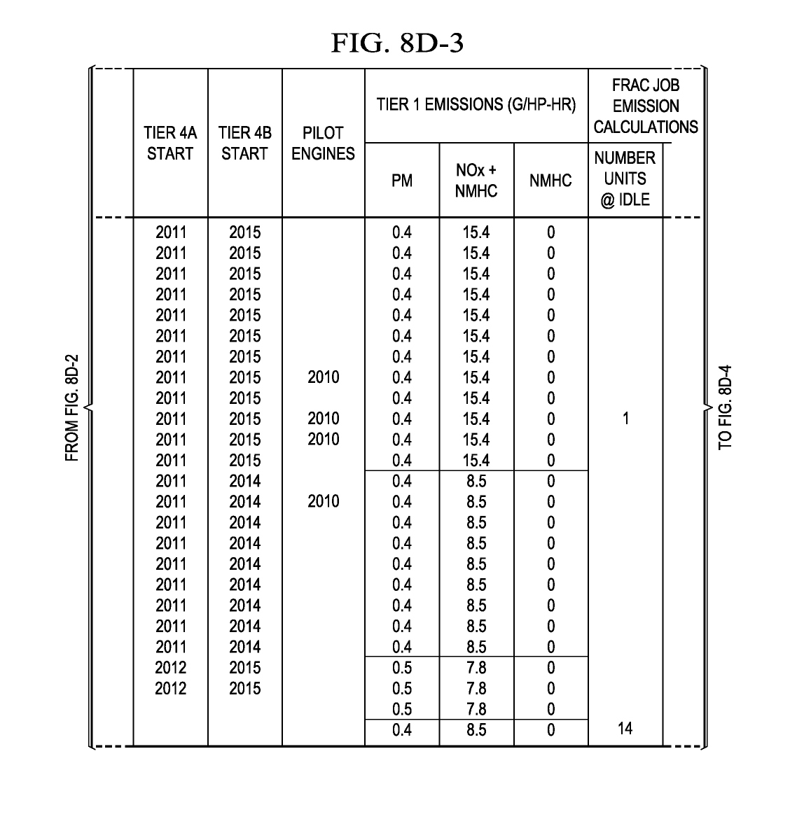

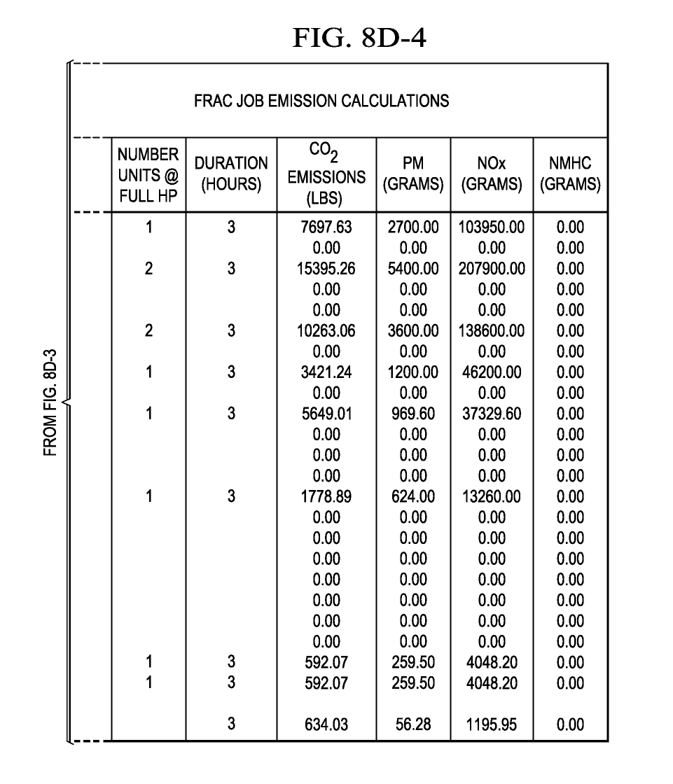

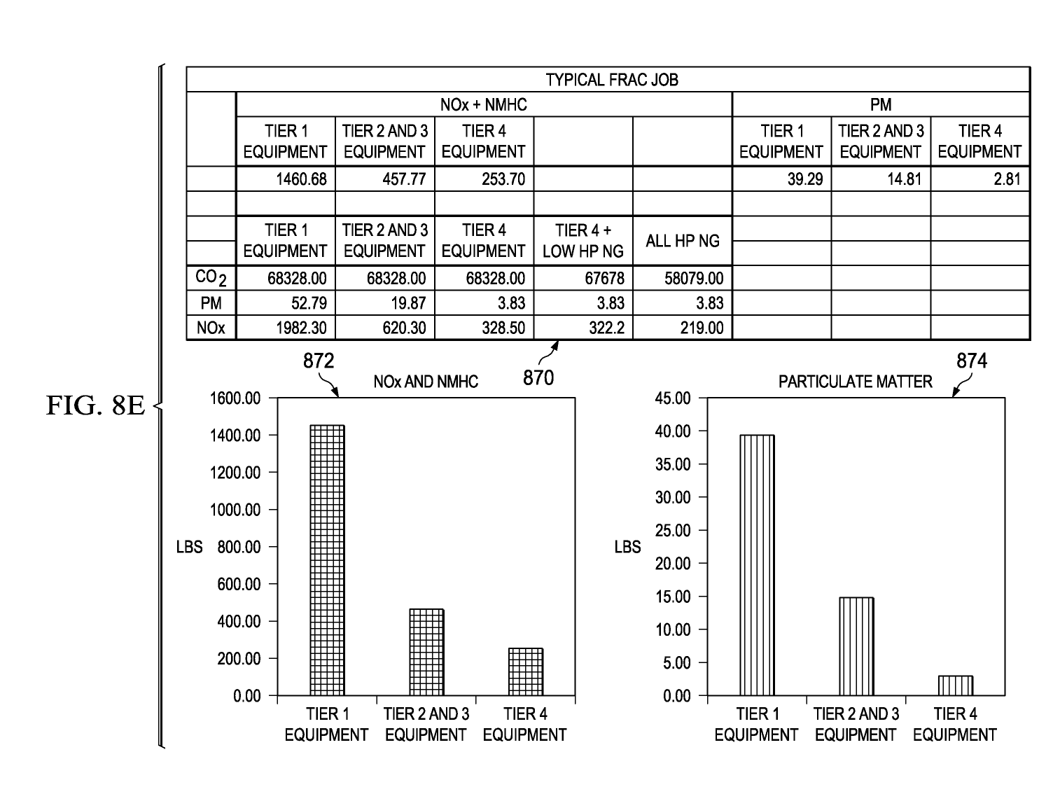

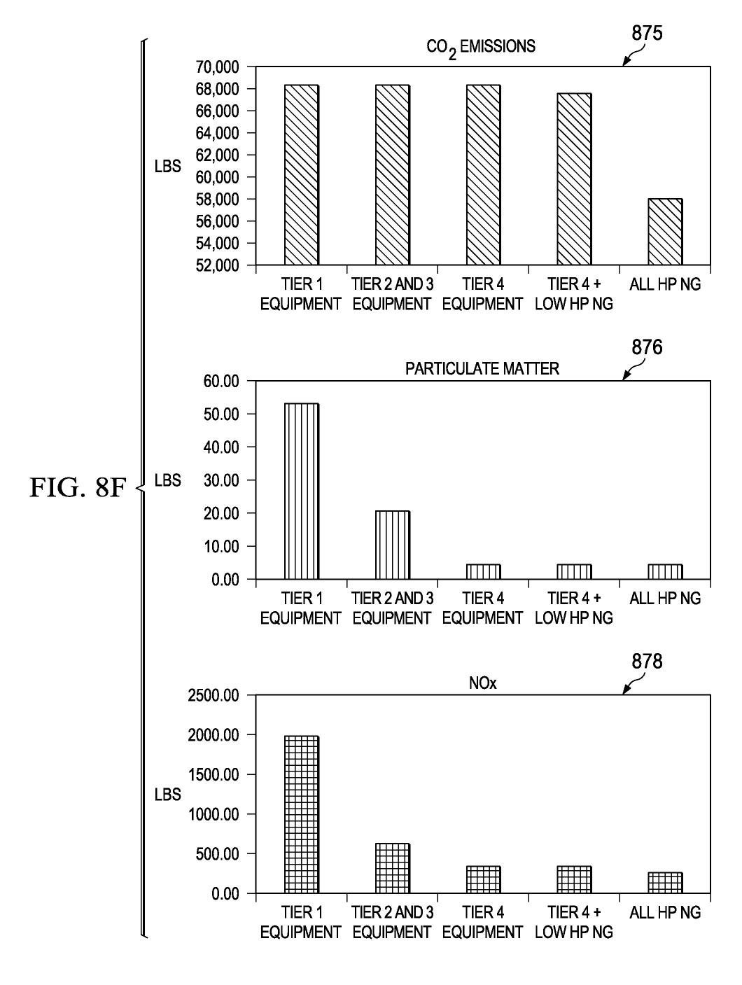

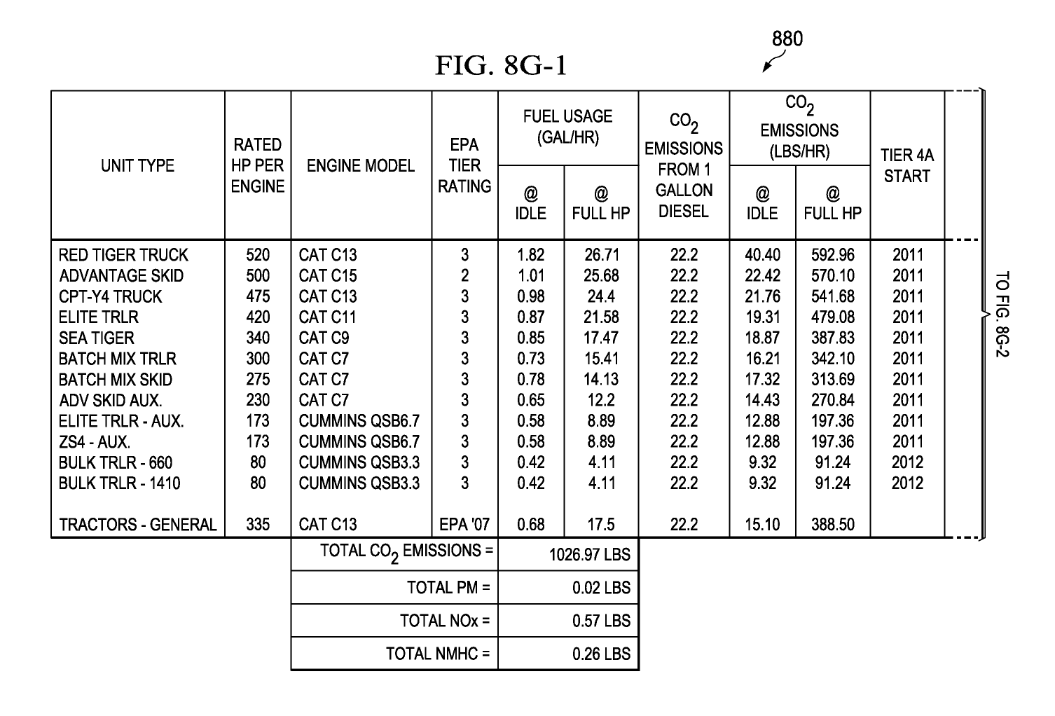

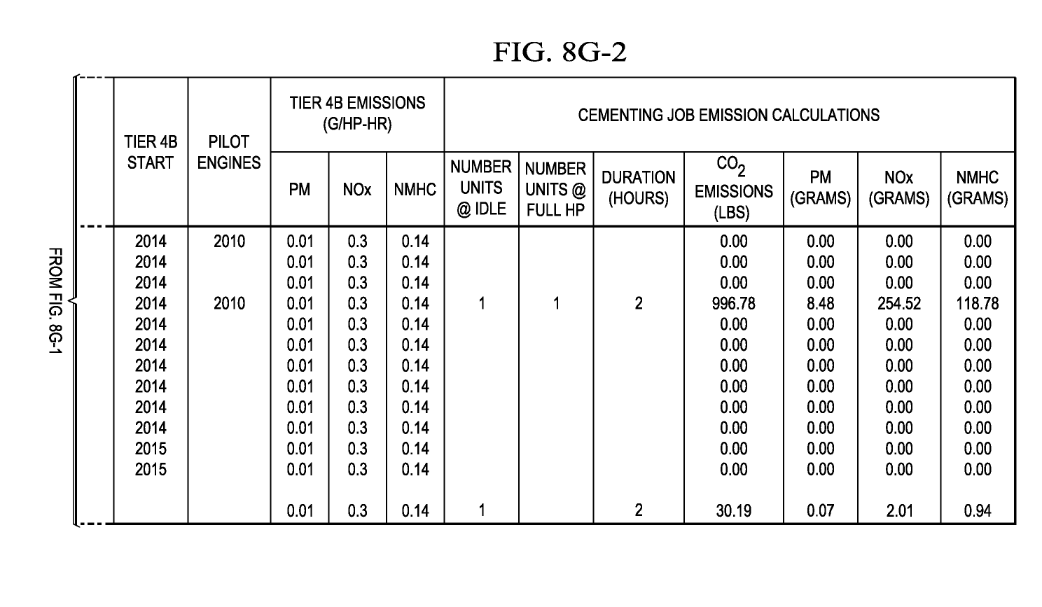

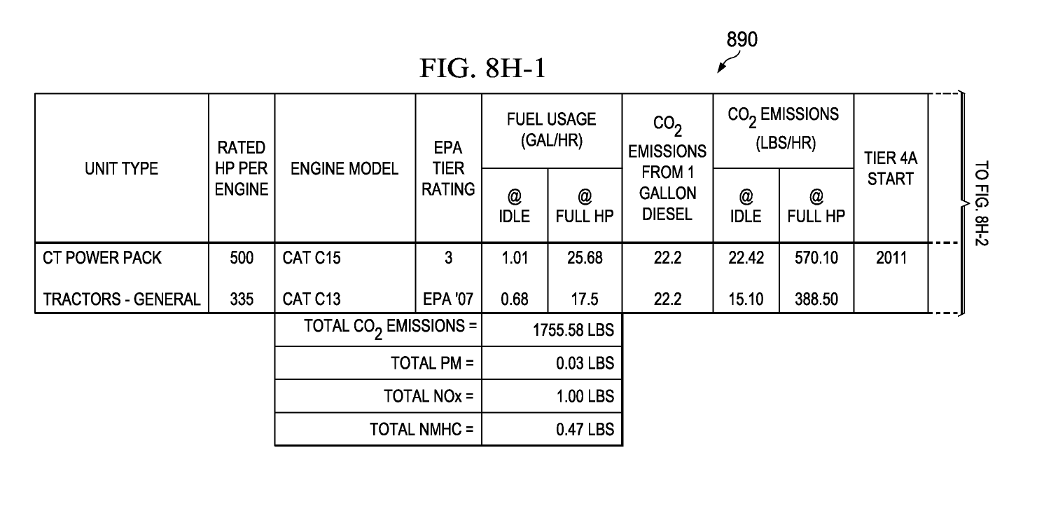

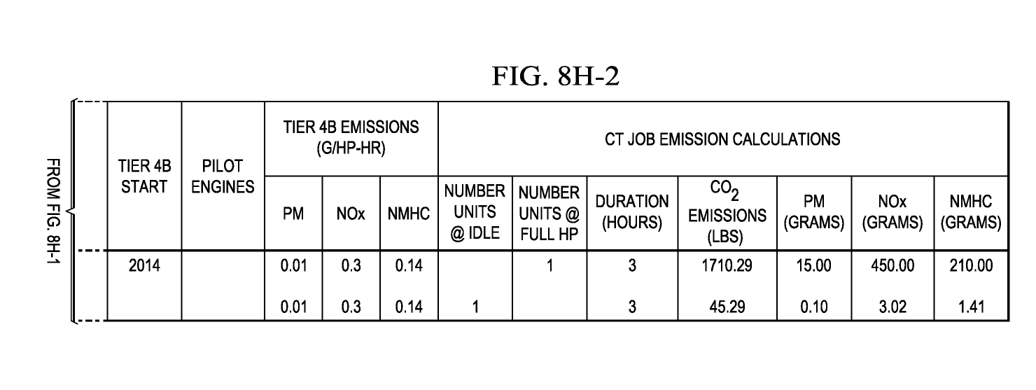

The job plan/emissions report 346 may be viewed on a display as part of the user interface 330, may be printed or downloaded as a spreadsheet or other type of file, or may be electronically stored or communicated to a remote site for storage, viewing, reporting, display or downloading. FIGS. 8A-H illustrate several embodiments of the job plan/emissions report 346 including exemplary equipment data 342, emissions data 344, and equipment utilization data 345.

The equipment 302 may upload utilization data electronically via a wireless or other link to the emissions tracking system 300. Alternatively, some or all utilization data may be collected manually and uploaded into the emissions tracking system 300 via the user interface 330. In a particular embodiment, the equipment 302 may include a data acquisition unit 350 coupled to the equipment 302 and/or the engine or engines of the equipment. The data acquisition unit 350 may communicate directly or indirectly with equipment or engine sensors to collect and store sensed data. The sensed data may include one or more types of utilization data 345. In one embodiment, the data acquisition unit 350 may comprise an electronic control module (ECM) or other on-board system that collects or accesses data collected during engine use. In the ECM embodiment, the data may be captured along with other job or operating parameters and transmitted, for example, to a data acquisition and/or control system through a J1939 data link. In another embodiment, the data acquisition and/or control system may directly capture engine emissions. In this embodiment sensors may be placed in the engine and/or exhaust system to directly determine emissions in real-time during operation of the engine.

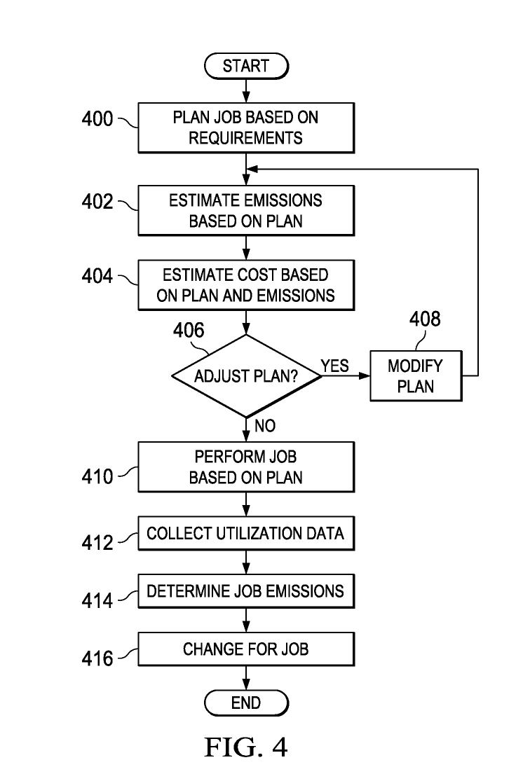

FIG. 4 illustrates one embodiment of a method, implemented at least in part by computer, for planning, conducting and charging for a job 200 based on engine exhaust emissions generated by the job 200. In this embodiment, the job 200 is fracture job for a subterranean oil well 202. It will be understood that other suitable jobs may be planned, conducted and charged as described in connection with well jobs based on engine exhaust emissions without departing from the scope of the present disclosure. Thus, a premium may be charged for jobs 200 that are performed while only producing limited or low emission. In another embodiment, the total cost of the job 200, including the cost of engine exhaust emissions, may be determined in the planning phase and the job plan adjusted to minimize the total cost of the job 200 by balancing the costs of equipment, time, materials and engine exhaust emissions.

Referring to FIG. 4, the method begins at step 400 in which the job 200 is planned based on requirements for the job 200. For a well bore fracture, the job plan may include, for example, the number and types of equipment 302 such as sand equipment 104, gel equipment 106, blender equipment 108, pump equipment 110, generator equipment 112, positioning equipment 114 and control equipment 116 to be used to perform the job 200. The job plan may also include a transportation plan detailing the locations from which equipment and materials will be sourced so that emissions exhaust emissions from transport may be determine based on utilization data from the transport equipment.

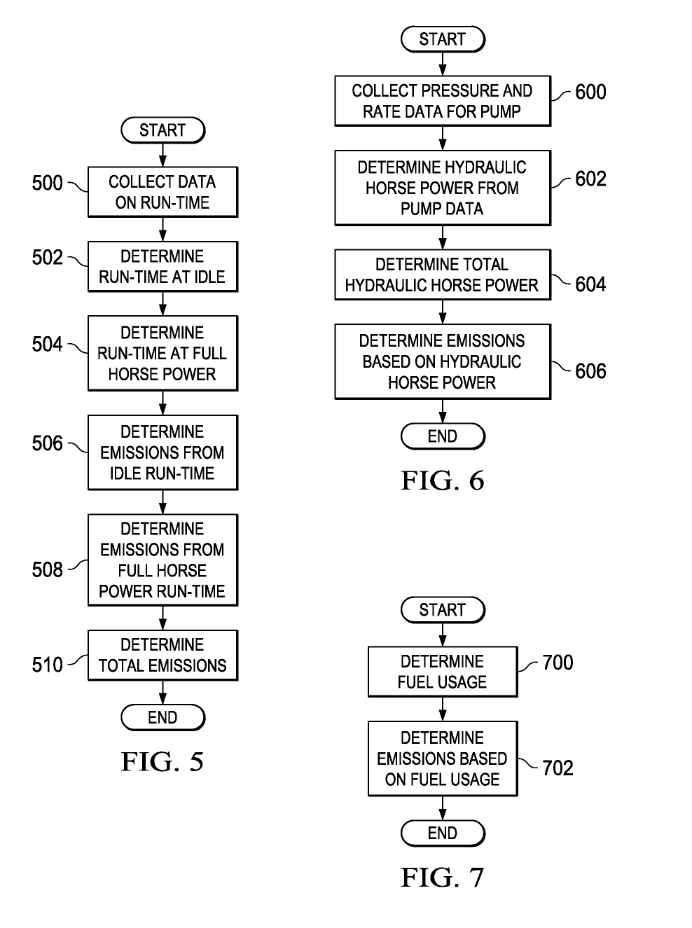

Next, at step 402, engine exhaust emissions are determined for the job 200 based on the job plan. The engine exhaust emissions may be accurately determined for the plan by projecting, calculating or estimating engine exhaust emissions based on the planned equipment 302 and utilization of the equipment 302 by, for example, using the methods described in connection with FIGS. 5, 6, 7 and/or 8.

At step 404, the total cost of the job 200 is estimated based on the plan and including the costs of engine exhaust emissions. For example, the cost of the job 200 may comprise the cost of equipment 302, materials, labor, transport and engine exhaust emissions. The cost of the engine exhaust emissions may be determined by first determining the amount of emissions of different pollutants generated by the job and then the cost to the company performing the job and/or the company for which the job is performed of the emissions. For example, a company may be charged for emissions or need to buy emission credits to cover the emissions generated. The cost of emissions may also be in non-monetary terms, such as, for example, the cost of good or bad will or publicity stemming from performing low emissions jobs 200 versus high emissions jobs 200. In one embodiment, the job plan including equipment 302, equipment utilization, determined engine exhaust emissions and job cost may be incorporated into or form the job plan/emissions report 346.

At decisional step 406, it is determined whether the job plan/emissions report 346 should be adjusted. If job plan/emissions report 346 is adjusted, the Yes branch of the decisional step 406 leads to step 408 where the job plan/emissions report 346 is modified to adjust, for example, costs, engine exhaust emissions, equipment 302, and/or job parameters. Step 408 returns to step 402 where engine exhaust emissions are again determined based on the adjusted job plan/emissions report 346. Returning to decisional step 406, when the job plan/emissions report 346 is finalized, the No branch of decisional step 406 leads to step 410.

At step 410, the job 200 is performed based on the job plan/emissions report 346. It will be understood that the job 200 may deviate from the job plan/emissions report 346 based on unexpected or other site or job conditions. Next, at step 412, engine utilization data from equipment 302 used on the job 200 is collected in real-time or periodically during the job 200 or after competition of the job 200. Engine utilization data may also be collected for equipment 302 used to transport other equipment 302, materials or labor to and from the job 200.

At step 414, engine exhaust emissions are determined for the job 200 based on the utilization data collected during the job 200. The engine utilization data may, as previously described, include engine run-time, engine load, time of use at full or other horsepower, fuel usage, pump pressure and rates and/or other data collected from operators and/or by sensors for the equipment 302 and engines utilized to perform the job 200. The engine exhaust emissions may in one embodiment be determined in real-time during the job and the operating parameters of the job adjusted to meet or control engine exhaust emissions and/or other part of job cost.

At step 416, the job is charged for based on total cost including the cost of engine exhaust emissions, including savings from reduced emissions generated by the job 200, in addition to other cost such job equipment 302, duration, labor, and materials. Step 416 leads to the end of the process in which well or other jobs 200 are planned based on engine exhaust emissions that will be produced by the job 200, conducted, in one embodiment, based on real-time tracking of engine exhaust emissions produced during the job and charged for based on the level of engine exhaust emissions generated, including emission reductions by the job 200.

FIG. 5 illustrates a method, implemented at least in part by computer, for determining engine exhaust emissions in accordance with one embodiment of the present disclosure. In this embodiment, data is collected in real-time during performance of a job 200. It will be understood that data may be otherwise suitably collected and engine exhaust emissions otherwise suitably determined without departing from the scope of the present disclosure.

Referring to FIG. 5, the method begins at step 500 in which utilization data on engine-run time is collected during the job 200. At step 502, run-time of each engine at idle is determined. At step 504, run-time of each engine at full horsepower is determined. Run-time at full horsepower may, in one embodiment, be any run-time other than at idle. Run-time at idle, full horsepower or other load state may be determined automatically based on sensed data, may be recorded by an operator or may be estimated during or after the job 200.

Proceeding to step 506, engine exhaust emissions during idle run-time are determined for each item of equipment 302, or engine. At step 508, engine exhaust emissions during full horsepower run-time are determined for each item of equipment 302, or engine. At step 510, total emissions for each item of equipment 302, or engine, are determined based on emissions generated during idle and full horsepower run-time. As previously described, the engine exhaust emissions may, in one embodiment include but are not limited to, CO₂, PM, NO_{X} and NMHC emissions. Step 510 leads to the end of the process in which total engine emissions during a job are determined. The determined engine exhaust emissions may be used to charge for the job, to track total emissions by or for a company or time period and/or for reporting purposes.

FIG. 6 illustrates a method, implemented at least in part by computer, for determining engine exhaust emissions in accordance with another embodiment of the present disclosure. In this embodiment, engine exhaust emissions for an engine, or item of equipment 302, driving a pump are determined based on operating parameters of the pump. It will be understood that engine exhaust emissions may be determined for engines and equipment driving suitable types of units based on operating parameters of the units where engine horsepower or fuel usage can be accurately determined, based on operating parameters of the unit.

Referring to FIG. 6, the method begins at step 600 in which pressure and rate data are collected for the pump. The pump may, for example, be a high pressure pump mounted on a pump truck. At step 602, hydraulic horsepower used to drive the pump is determined based on the pressure and rate utilization data. In one embodiment, the pump's pressure and rate data is used as a dynamometer to measure the real-time hydraulic horsepower.

At step 604, parasitic losses for the equipment 302, engine, are added to the real-time hydraulic horsepower to determine total hydraulic horsepower produced the engine, or equipment 302. Next, at step 606, engine exhaust emissions are determined based on the total hydraulic horsepower. As used herein, the term “based on” means based on at least the identified criteria and thus other criteria may also be used. In one embodiment, engine exhaust emissions may be determined from total hydraulic horsepower by determining fuel usage of the engine at the horsepower load and then determining emissions based on the fuel usage. The engine emissions may be otherwise suitably determined from engine hydraulic horsepower without departing from the scope of the present disclosure. Step 606 leads to the end of the process by which engine exhaust emissions are determined for equipment 302 based on operation performed by a unit driven by an engine of the equipment.

FIG. 7 illustrates a method, implemented at least in part by computer, for determining engine exhaust emissions based on fuel usage in accordance with one embodiment of the present disclosure. In this embodiment, fuel usage may be directly sensed during or after operation of an engine or equipment item or may be recorded by an operator during or after the job 200. For example, fuel usage may be captured in an engine's ECM and transmitted to an ACE system through a J1939 data link.

Referring to FIG. 7, the method begins at step 700 in which fuel used by an engine or item of equipment 302 is determined. Next, at step 702, engine exhaust emissions are determined for the engine or equipment item during the job 200 based on fuel usage. In one embodiment, engine exhaust emissions may be determined by use of the utilization data 345 based on the amount and type of engine exhaust emissions generated by the amount of fuel used and the type of fuel used. For example, the fuel may comprise diesel fuel, natural gas (NG) fuel or other fuel. Step 702 leads to the end of the method by which engine exhaust emissions are determined based on fuel usage. In another embodiment, emissions may be directly sensed and totaled and/or accumulated in the job planning/emissions report 346.

Referring to FIGS. 8A-8H, various embodiments of the job plan/emissions report 346 are illustrated. In particular, FIGS. 8A-8D illustrates a job plan/emission report 346 for fracture jobs. FIGS. 8E-8F illustrates charts that may be produced as part of or from the job plan/emissions report 346 and may be determined from data in the job plan/emissions report 346. FIG. 8G illustrates a job plan/emissions report 346 for a cementing job for a well 202. FIG. 8H illustrates a job plan/emissions report 346 for a coiled tubing job for a well 202. The job plan/emissions report 346 may comprise other, different, or a subset of the data illustrated in FIGS. 8A-8H. For example, only the total resulting emissions from a job 200 or during a period of time may be displayed in one embodiment.

Referring to FIG. 8A, the illustrated job plan/emission report 800 may comprise a spreadsheet stored, displayed, printed or otherwise output in tangible form. In this embodiment, the job plan/emission report 800 may include a column for each of a plurality of types of equipment data 342 including unit type 802, rated horsepower per engine 804, engine model 805, fuel usage 806 including at idle and at full horsepower, CO₂ emissions 808 including at idle and at full horsepower. Each type of equipment including an engine that is or may be used for the job 200 may be listed in the job plan/emission report 800 in rows of the spreadsheet. The job plan/emission report 800 may also include a column for each of a plurality of types of emissions data 344 including CO₂ emissions 810 in pounds from one gallon of diesel fuel, Tier 4A start dates 812, Tier 4B start dates 814, pilot engines 815, Tier 4B emissions 816 in gram per horsepower-hour including for PM, NO_{X} and NMHC emissions, Tier 2 and 3 emissions 818 in gram per horsepower-hour including for PM, NO_{X} and NMHC emissions, and Tier 4 emissions 820 in gram per horsepower-hour including for PM, NO_{X} and NMHC emissions.

The job plan/emission report 800 may include a column for each of a plurality of types of equipment utilization data 345 including EPA Tier rating 822, NG engine 824, number of units at idle 825, number of units at load 826, load factor 828 and job duration 830 in hours. Based on the equipment data 342, emissions data 344 and the equipment utilization data 345, the engine exhaust emissions may be determined in the job plan/emission report 800 during job planning, after the job or during the job 200. For example, diesel engine emissions including but limited to CO₂, PM, NO_{X} and NMHC emissions may be determined and displayed in diesel engine emissions columns 832. Likewise, NG engine emissions including but not limited to CO₂, PM, and NO_{X} may be determined and displayed in NG engine emissions columns 834.

In the illustrated embodiment, engine exhaust emissions may be determined for each unit type of equipment based on the number of units at idle, the number of units at full horsepower and the run-time or duration of the use of each of the units. As used herein, the term “each” means every one of at least a subset of the identified items and thus may be some, all or substantially all of the identified items. For example, the fuel usage may be determined for each equipment item at each load level based on the duration of the load level and the resulting engine exhaust emissions determined from the amount of fuel used. The total emissions for the job 200 may be determined by adding together the total engine exhaust emissions produced by the equipment used for the job 200. The equipment used for the job 200 may include transport vehicles used to bring and/or return labor, materials or equipment to the site.

The job plan/emission report 800 may include cumulative or total engine exhaust emissions 835 for the job 200 and/or for periods of time. For example, engine exhaust emissions for a job 200 may be totaled by emission type, including CO₂, PM, NO_{X} and NMHC emissions. Cumulative exhaust emissions may be total by year or other time period.

Referring to FIG. 8B, another embodiment of a job plan/emission report 840 is illustrated. The job plan/emission report 840 may also comprise a spreadsheet with data organized in columns and rows as discussed in connection with job plan/emission report 800 of FIG. 8A. In job plan/emission report 840 the equipment is operated, or assumed to be operated, only at idle or full horsepower. Thus specific loading of the engines or equipment need not be determined. Equipment is assumed to be at full horsepower when not at idle in order to ensure the emissions are not under reported. In another embodiment, a standard profile of horsepower during different job states equipment 302 or engine may be used in connection with run-time data to accurately determine horsepower.

Referring to FIGS. 8C-D, still other embodiments of job plan/emission reports 850 and 860 are illustrated. The job plan/emission reports 850 and 860 may also each comprise a spreadsheet with data organized in columns and rows as discussed in connection with job plan/emission report 800 of FIG. 8A. In job plan/emission reports 850 and 860, engine exhaust emissions are determined based on fuel usage.

Referring to FIGS. 8E-8F, engine exhaust emissions may be graphically displayed by job 200, period, equipment type or item of equipment. In the illustrated embodiment, engine exhaust emissions including CO₂, PM, NO_{X} and NMHC are determined and shown in chart 870 for a typical fracture job by equipment type, including Tier 1, Tier 2 and 3, and Tier 4 equipment. In particular, graph 872 charts pounds of NO_{X} and NMHC emissions for each of Tier 1, Tier 2 and 3, and Tier 4 equipment. Graph 874 charts pounds of PM emissions for each of Tier 1, Tier 2 and 3, and Tier 4 equipment. Graph 875 charts pounds of CO₂ emissions for each of Tier 1, Tier 2 and 3, Tier 4, Tier 4+ (low horsepower NG), and all horsepower NG equipment. Graph 876 charts pounds of PM emissions for each of Tier 1, Tier 2 and 3, Tier 4, Tier 4+ (low horsepower NG), and all horsepower NG equipment. Graph 878 charts pounds of NO_{X} emissions for each of Tier 1, Tier 2 and 3, Tier 4, Tier 4+ (low horsepower NG), and all horsepower NG equipment. Engine exhaust emissions may be otherwise suitably graphed and/or displayed.

Referring to FIG. 8G, a job plan/emission report 880 for a cementing job is illustrated. The job plan/emission report 880 may comprise a spreadsheet with data organized in columns and rows as discussed in connection with job plan/emission report 800 of FIG. 8A. In job plan/emission report 880, engine exhaust emissions are determined based on run-time at idle and at full horsepower.

Referring to FIG. 8H, a job plan/emission report 890 for a well coiled tubing job is illustrated. The job plan/emission report 890 may comprise a spreadsheet with data organized in columns and rows as discussed in connection with job plan/emission report 800 of FIG. 8A. In job plan/emission report 890, engine exhaust emissions are determined based on run-time at idle and at full horsepower. Engine exhaust emissions may be otherwise suitable determined for cementing, wireline, other well and/or other jobs performed with equipment 302 that use internal combustion engines to perform the job.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer-implemented method for determining engine exhaust emissions for a job, comprising:
storing utilization data for each of a plurality of engines used for a job;
determining by operation of a computer processor an amount of engine exhaust emissions for each engine based on the utilization data;
determining by operation of a computer processor an amount of engine exhaust emissions for the job based on the amount of engine exhaust emissions for each engine; and
storing the amount of engine exhaust emissions for the job.

2. The method of claim 1, further comprising:
determining by operation of a computer processor horsepower produced by each engine based on the utilization data; and
determining by operation of a computer processor the amount of engine exhaust emissions for each engine based on the engine's horsepower.

3. The method of claim 1, further comprising:
determining by operation of a computer processor fuel usage by each engine for the job based on the utilization data; and
determining the amount engine exhaust emission for each engine based on the engine's fuel usage.

4. The method of claim 1, further comprising capturing utilization data for each engine from sensors coupled to the engine.

5. The method of claim 4, further comprising:
capturing the utilization data for each engine with an electronic control module (ECM) of the engine; and
transmitting the utilization data over a communication link for use by the computer system.

6. The method of claim 1, wherein the utilization data includes at least one of engine run-time, engine horsepower, and fuel usage.

7. The method of claim 6, wherein the job comprises a well fracture job, the well fracture job comprises a plurality of pump trucks each having an engine to drive the a pump for the well fracture job, and the utilization data comprises rate and pressure data for each pump.

8. The method of claim 1, further comprising:
determining by operation of a computer processor the amount of engine exhaust emissions for the job in real-time; and
dynamically adjusting operation of the job in real-time to maintain engine exhaust emissions for the job below a target level.

9. The method of claim 1, further comprising:
storing the utilization data for a plurality of jobs performed over a first period of time;
determining by operation of a computer processor an amount of engine exhaust emissions produced by jobs during a second period of time within the first period of time; and
storing the amount of engine exhaust emission produced by jobs during the second period of time.

10. The method of claim 1, wherein the engine exhaust emissions comprise carbon dioxide (CO₂), particulate matter (PM), nitrogen dioxides (NOₓ), and non-methane hydrocarbon (NMHC) emissions.

11. A method for determining cost of a job, comprising;
storing a plan for a job, the plan including equipment to be used for the job and operating parameters for the equipment;
determining by operation of a computer processor an amount of engine exhaust emissions produced by the equipment when operated at the operating parameters of the plan;
determining by operation of a computer processor an amount of engine exhaust emissions produced by job based on the amount of engine exhaust emissions produced by the of equipment when operated at the operating parameters of the plan;
storing the amount of the engine exhaust emission produced by job;
determining by operation of a computer processor a cost of the engine exhaust emissions based on the amount of engine exhaust emissions produced by job; and
determining by operation of a computer processor a cost for the job including the cost of the engine exhaust emissions for the job.

12. The method of claim 11, further comprising modifying the plan for the job to reduce the engine exhaust emissions for the job in order to reduce the cost of the job.

13. A system for determining engine exhaust emissions for a job, comprising:
memory operable to store utilization data for each of a plurality of engines used for a job; and
one or more processors operable to:
determine an amount of engine exhaust emissions for each engine based on the utilization data;
determine an amount of engine exhaust emissions for the job based on the amount of engine exhaust emissions for each engine; and
store in the memory the amount of engine exhaust emissions for the job.

14. The system of claim 13, the one or more processors further operable to:
determine horsepower produced by each engine based on the utilization data; and
determine the amount of engine exhaust emissions for each engine based on the engine's horsepower.

15. The system of claim 13, the one or more processors further operable to:
determine fuel usage by each engine for the job based on the utilization data; and
determine the amount of engine exhaust emissions for each engine based on the engine's fuel usage.

16. The system of claim 13, further comprising sensors coupled to each of the engines to capture utilization data for the engine.

17. The system of claim 16, further comprising:
an electronic control module (ECM) coupled to each of the engines to capture utilization data for the engine; and
a communications link to transmit the utilization data from the ECM for storage in the memory.

18. The system of claim 13, wherein the job comprises a well job, further comprising:
a plurality of pump trucks at a site of the well job, each pump truck having an pump engine to drive the a pump for the well job;
the utilization data comprising rate and pressure data for the pumps; and
the one or more processors operable to determine an amount of engine exhaust emissions for each pump engine based on the pressure and a rate data for the pumps.

19. The system of claim 13, the one or more processors operable to:
determine the amount of engine exhaust emissions for the job in real-time;
dynamically adjust operation of the job in real-time to maintain engine exhaust emissions for the job below a target level.

20. The system of claim 13, wherein the engine exhaust emissions comprise carbon dioxide (CO₂), particulate matter (PM), nitrogen dioxides (NOₓ), and non-methane hydrocarbon (NMHC) emissions.
